(19) United States
(12) Patent Application Publication
(10) Pub. No.: US 2019/0063962 A1
(43) Pub. Date: Feb. 28, 2019

(54) Optical Fiber

(71) Applicant: Fibercore Limited, Southampton (GB)

(72) Inventors: Christopher Emslie, Southampton (GB); Andrew Simon Webb, Southampton (GB); Laurence James Cooper, Southampton (GB)

(21) Appl. No.: 16/020,169

(22) Filed: Jun. 27, 2018

(30) Foreign Application Priority Data
Jun. 27, 2017 (GB) 1710242.7

(51) Int. Cl. G01D 5/353; G02B 6/02; G02B 6/036; C03B 37/03; C03C 25/106

(52) U.S. Cl. CPC G01D 5/35361; G02B 6/02042; G02B 6/02057; G02B 6/03627; C03B 2203/22; C03C 25/106; C03B 2201/31; C03B 2201/14; C03B 37/032

(57) ABSTRACT

There is provided an optical fiber for providing increased sensitivity in sensing applications by increasing the Rayleigh backscatter coefficient of the fiber while maintaining tolerable levels of signal attenuation (e.g., less than 20% over 10 km). Such an optical fiber comprises a core, a first cladding layer and a second cladding layer. The core comprises at least one core dopant selected from the range of: germanium, phosphorus, aluminium, boron, fluorine. The at least one core dopant is used to increase the core refractive index and enhance the core Rayleigh backscatter coefficient. The first cladding layer comprises at least one dopant selected from: germanium, phosphorus, aluminium, boron, fluorine; wherein at least one first cladding layer dopant is used to reduce the first cladding layer refractive index. The signal attenuation generated in the fiber is less than 20% over 1 km.

### CROSS-REFERENCE TO RELATED APPLICATIONS

This application claims the benefit of priority under 35 U.S.C. § 119 of United Kingdom Patent Application no. 1710242.7, filed Jun. 27, 2017, which is hereby incorporated herein by reference in its entirety.

### FIELD OF THE INVENTION

The present invention relates to an optical fiber, in particular an optical fiber providing increased Rayleigh backscatter for use in applications requiring increased sensitivity.

### BACKGROUND TO THE INVENTION

Advances in automation and remote management and an increase in the complexity of standard operating procedures carried out within various industries today have led to greater risks being placed upon personnel and equipment. To mitigate these risks, remote sensing methods are required to facilitate instantaneous and accurate remote monitoring of environmental conditions, equipment properties and signal quality.

In recent years the use of ‘distributed’ sensors has increased significantly, in which a sensing-element that enables various measurands is laid around an environment. These measurands include but are not limited to temperature (Distributed Temperature Sensing), vibration/acoustic signals (Distributed Vibration Sensing/Distributed Acoustic Sensing), pressure (Distributed Pressure Sensing), flow (Distributed Flow Sensing) and gases/chemicals. Application fields include Oil and Gas exploration and asset management (including monitoring of the hydro-fracking process), pipeline leak detection, chemical processing, fire detection, border security/intruder detection.

Expansions in hydrocarbon exploration, coupled with the ever reducing availability of hydrocarbon sources has driven the industry to explore deeper, more isolated and altogether more risky regions. This is now coupled with an additional effort to partially resolve the issue of global demand through exploration of resources historically considered “unconventional”. The extraction of such resources typically demands a greater complexity of technological input and inherently places a higher level of risk upon site operators and equipment.

Similarly, in utilities monitoring and management systems, the use of remote detection systems for instant updates pertaining to changes in the environment or pipeline leaks could prove extremely advantageous in dramatically increasing efficiency of problem solving.

Most commercial distributed sensing techniques rely on one or other of the various mechanisms active within the core of an optical fiber—typically Brillouin, Raman or Rayleigh scattering. The use of scattering mechanisms is advantageous, because the dynamic and physical range/reach of the sensor is preserved as the intensity of the measurand increases. Conversely if induced attenuation is used, then the range of the sensor decreases as the intensity of the measurands increases.

One key class of distributed optical sensors is distributed acoustic or distributed vibration sensing (DTS/DAS) used to detect vibrations from a wide range of sources, from the footfall of intruders, through gas or fluid exiting from the leak in a pipeline, to hydro-fracking (‘fracking’) and seismic surveying. These sensors work through detection of variations in the Rayleigh scattering within the fiber induced by vibration. There is an aim to increase the sensitivity/dynamic range within all of these remote sensing methods. By increasing both the magnitude and efficiency of capture of this Rayleigh scattering, and by preserving low optical attenuation levels the distance reach of this class of sensors when compared with sensors using conventional fiber designs.

Within industries using sensing techniques, lossless technologies are highly sought after for a number of reasons. The ever-increasing depth of oil wells, together with global legislation on pipeline monitoring make low-attenuation particularly relevant and important to the oil and gas exploration and utilities management industries among several others.

Existing methods for increasing backscatter typically involve increasing inhomogeneity within the core of an optical fiber. This is invariably carried out by increasing core-doping levels. Several existing methods of increasing the doping levels within the core of an optical fiber are responsible for increased optical attenuation, thereby reducing the usefulness of the fiber in long-distance distributed sensors.

An improved optical fiber for remote monitoring is required. It is therefore desired to provide an optical fiber with a more optimum core doping regime that increases to an advantageous level the signal backscatter, whilst limiting the amount of resultant signal attenuation.

### SUMMARY OF THE INVENTION

In accordance with a first aspect of the present invention there is provided an optical fiber for enhancing the sensitivity of a sensing system, the optical fiber comprising; at least one core having a core diameter, a core numerical aperture, a core refractive index and a core Rayleigh backscatter coefficient; a first cladding layer having a first cladding layer thickness, and a first cladding layer refractive index; wherein the core comprises at least one core dopant selected from the range of: germanium, phosphorus, aluminium, boron, fluorine; wherein at least one core dopant is used to increase the core refractive index and enhance the core Rayleigh backscatter coefficient; the first cladding layer comprising at least one first cladding layer dopant selected from the range of: germanium, phosphorus, aluminium, boron, fluorine; wherein at least one first cladding layer dopant is used to reduce the first cladding layer refractive index; wherein the signal attenuation generated in the fiber is less than 20% over 1 km; and wherein the core numerical aperture is greater than 0.13.

The optical fiber according to the first aspect of the present invention provides a dopant regime that achieves a suitable increase in the Rayleigh backscatter coefficient. As such, an optical signal provided to the core of the optical fiber will result in a greater amount of measurable backscatter. This is achieved by providing an optical fiber comprising low levels of up-doping within the core, therefore increasing the core refractive index. The optical fiber further comprises low levels of down-doping of the first cladding layer, thereby reducing the first cladding layer refractive index. The simultaneous up-doping of the core and down-doping of the first cladding layer provides a critical angle that preferably provides a more optimum acceptance angle, thereby optionally permitting a higher numerical aperture (NA). Applications of optical fibers possess different tolerance thresholds relating to signal attenuation measured as a percentage signal loss per unit distance. The dopant regime provided in the optical fiber of the present invention is such that the signal attenuation that results from the increased level a signal backscatter remains within a tolerable range for desired applications. This tolerable range is preferably between 0% attenuation over 1 km and 20% attenuation over 1 km. Co-dopants may be employed to improve the siting of scattering-centres, thereby increasing the overall amount of backscatter generated.

The core dopant of the optical fiber in accordance with the first aspect of the present invention preferably comprises one selected from the range: germanium at a concentration of up to 28 mol %; boron at a concentration of up to 24 mol %; fluorine at a concentration of up to 10 mol %.

Preferably the optical fiber according to the first aspect of the present invention comprises a core dopant of germanium in a concentration greater than 0 mol %, wherein the upper limit of core germanium dopant concentration is 28 mol %. Alternatively the core dopant is boron in a concentration greater than 0 mol %, wherein the upper limit of core boron concentration is 24 mol %. In alternative embodiments the core dopant is fluorine in a concentration greater than 0 mol %, wherein the upper limit of core fluorine concentration is 10 mol %. Alternative core dopants may comprise aluminium or phosphorous.

Preferably, the optical fiber according to the first aspect of the present invention possesses a core numerical aperture of 0.13 to 0.15, preferably the core numerical aperture is greater than 0.17. More preferable is an embodiment of the first aspect of the present invention wherein the core numerical aperture is greater than 0.22. Most preferably, the optical fiber according to the first aspect of the present invention has a core numerical aperture greater than 0.25.

The fiber is preferably designed with a high numerical aperture (NA), typically in the range of 0.17 to 0.22 but always greater that the 0.13 used in standard telecommunications fibers. This high NA increases the optical power density and therefore increases the capture of light scattered-back towards the optical source through the mechanism of Rayleigh backscattering. The high NA of this fiber is permitted by the higher acceptance angle determined by the corresponding up-doping of the core and down-doping of the first cladding layer, which produces a smaller critical angle. The increase in efficiency of this capture varies approximately in accordance with the following relationship:

$${θ}_{acc} = arc sin ( \frac{1}{{n}_{0}} \sqrt{{n}_{core}^{2} - {n}_{cladding}^{2}} )$$

By increasing both the magnitude and efficiency of capture of the Rayleigh scattering present within a fiber, the present invention provides an optical fiber with increased sensitivity and dynamic range. By preserving low optical attenuation levels the distance reach of signals from this fiber is increased when compared with conventional fiber designs.

This high NA is attainable through a combination of the down-doping of the cladding and the up-doping of the core using suitable dopants, providing for an increased acceptance angle, thereby enabling the increase in the level of core doping to be limited and unacceptable levels of optical attenuation to be avoided. Nevertheless, the levels of index-raising dopant within the core may be significantly greater than those used in conventional, telecommunications-type fibers, thereby increasing the inherent level of Rayleigh backscatter generated. Using these techniques, it is anticipated that the amount of Rayleigh backscatter captured may be increased by a factor of 2 to 3 times above the levels possible using conventional, telecommunications-type optical fibers.

In a preferable embodiment of the first aspect of the present invention there is provided an optical fiber wherein the optical fiber diameter is in the range of 30 μm to 250 μm. Preferably the optical fiber diameter is in the range of 50 μm to 125 μm. Most preferably the optical fiber diameter is in the range of 50 μm to 80 μm.

The optical fiber diameter is determined according to the diameter of the core and the diameter of the cladding. The present invention preferably has a high numerical aperture, and the core diameter is therefore preferably small. Preferably the first cladding layer is also small, but wherein the first cladding layer diameter is not so small as to increase the likelihood of experiencing microbending-related loss. The first cladding layer diameter is also no so large as to present increased incidence of leakage loss. The preferable diameter range for an optical fiber according to the first aspect of the present invention is 50 μm to 80 μm.

The design of the optical fiber according to the first aspect of the present invention is such that the first cladding layer dimensions may be kept to a minimum while the fiber NA is maximised. The currently available technology is unable to provide such a design wherein sensitivity of the fiber is maximised and wherein loss is kept to a minimum. Preferably the optical mode is confined in the first cladding layer, without leakage to the un-doped second cladding layer.

In accordance with the present invention there is provided an optical fiber with enhanced Rayleigh backscatter coefficient and enhanced Rayleigh backscatter sensitivity as set out in the preceding description.

In accordance with a second aspect of the present invention there is provided a sensing system comprising; at least one optical fiber according any preceding claim as a sensing element, the optical fiber being arranged to detect at least one predetermined parameter linked to a change in the back-scatter; the sensing system further comprising; at least one input portion arranged to provide an optical signal and accept an optical signal; and at least one detector portion arranged to accept an output optical signal.

The system according to the second aspect of the present invention preferably incorporates an optical fiber according to the first aspect of the present invention. The sensing system is preferably used to detect changes in one or more predetermined measurands. The measurands are preferably detected through the use of an interrogatory optical signal provided to an optical fiber, wherein the structure of the optical fiber permits the provision of backscatter. Preferably the backscatter is detected by the sensing system, with a deviation from the expected backscatter being used to inform a change to a predetermined measurand.

The sensing system is preferably a distributed sensing system that incorporates the use of optical fibers as a sensing element. Such a system may preferably be a Distributed Temperature Sensing (DTS) system; a Distributed Vibration Sensing (DVS) system; a Distributed Acoustic Sensing (DAS) system; a Distributed Pressure Sensing (DPS) system; a Distributed Flow Sensing (DFS) system. Embodiments are conceivable wherein the system according to the second aspect of the present invention made be suitable for sensing additional measurands.

Application fields for the system according to the second aspect of the present invention preferably include oil and gas exploration and asset management (including monitoring of the hydro-fracking process), pipeline leak detection, chemical processing, fire detection, border security/intruder detection. Further embodiments are conceivable wherein additional applications for the above-mentioned system may be apparent.

In accordance with a third aspect of the present invention there is provided a method of manufacture of an optical fiber according to the first aspect of the present invention, the method comprising the steps of;
a) fabricating an optical fiber preform according to the desired specifications of an optical fiber as previously herein defined;
b) drawing an optical fiber from a drawing tower; and further comprising the step of,
c) coating said glass fiber with a protective coating layer.

The method of manufacture of an optical fiber according to the third aspect of the present invention is preferably used to manufacture an optical fiber according to the first aspect of the present invention.

In accordance with a fourth aspect of the present invention there is provided a method of manufacture of a sensing system according to the second aspect of the present invention, the method comprising the steps of;
a) fabricating an optical fiber preform according to the desired specifications of an optical fiber as previously herein defined;
b) drawing an optical fiber from a drawing tower; and further comprising the step of,
c) coating said glass fiber with a protective coating layer.

The method of manufacture of a sensing system according to the fourth aspect of the present invention is preferably used to manufacture a sensing system according to the second aspect of the present invention.

In accordance with a fifth aspect of the present invention there is provided an apparatus for the manufacture of an optical fiber according to the first aspect of the present invention, the apparatus comprising; a fiber drawing tower, including tensioning apparatus and furnace apparatus; further comprising a coating station, a curing station and product spool storage.

Preferably the apparatus according to the fifth aspect of the present invention is used in the method of manufacture according to the third aspect of the present invention. According to a more preferable embodiment, the apparatus according to the fifth aspect of the present invention is used to perform at least one step in the method of manufacture of a sensing system according to the fourth aspect of the present invention.

### BRIEF DESCRIPTION OF THE DRAWINGS

Specific embodiments will now be described by way of example only, and with reference to the accompanying drawings, in which:

FIG. 1 shows a cross-sectional diagram of an optical fiber according to a first aspect of the present invention;

FIG. 2 shows a graph displaying properties of an optical fiber according to a first aspect of the present invention; and

FIG. 3 shows a sectional diagram of a sensing system according to a second aspect of the present invention incorporating an optical fiber according to a first aspect of the present invention, manufactured using a method of manufacture according to a third aspect of the present invention, wherein the method of manufacture utilises in-part apparatus according to a fifth aspect of the present invention.

FIG. 4 is a flow diagram of a method of manufacturing an optical fiber.

### DETAILED DESCRIPTION

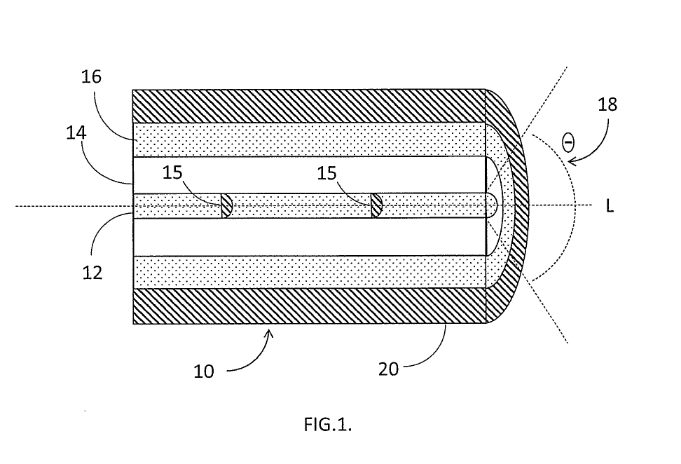

Referring to FIG. 1, a cross-sectional diagram of an optical fiber 10 according to a first aspect of the present invention is shown. The optical fiber 10 comprises an optical fiber core 12 arranged about a linear plane L and comprising a plurality of optical gratings 15, whereby about the optical fiber core 12 there is comprised a first cladding layer 14. Arranged about the first cladding layer 14 is comprised a second cladding layer 16. In the embodiment shown, the optical fiber 10 further comprises a coating 20, arranged to cover the circumferential area of the second cladding layer 16.

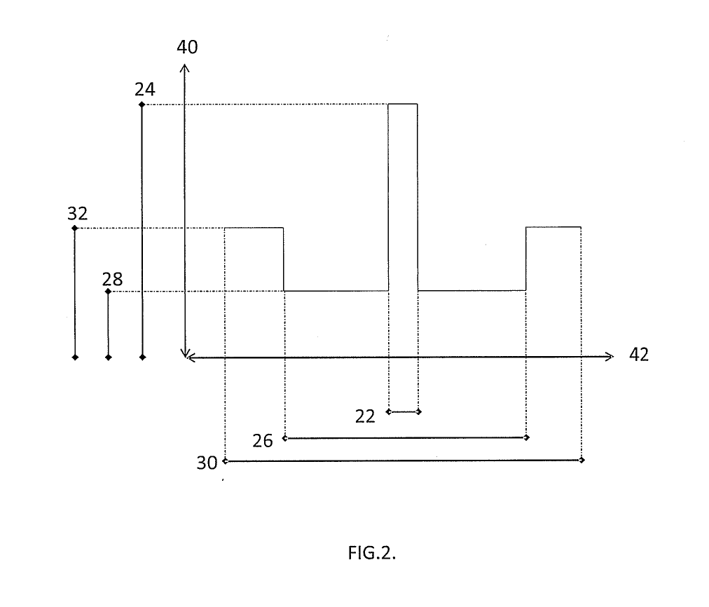

Referring to FIG. 2, a graphical representation of the iterative dimensions of the optical fiber layers emerging from the core can be seen on the horizontal axis 42, along with the corresponding refractive indices on the vertical axis 40. Optical fiber core 12 comprises up-doped silica, and therefore the optical fiber core refractive index 24 has been increased compared to the refractive index of un-doped silica. The optical fiber core refractive index 24 has been increased through the use of germanium-containing compounds.

The first cladding layer 12 comprises down-doped silica, and as such the first cladding layer refractive index 28 has been reduced from the refractive index of un-doped silica. The first cladding layer refractive index 28 has been reduced through the use of fluorine-containing compounds.

The corresponding increased optical fiber core refractive index 24 and reduced first cladding layer refractive index 28 provides a reduced critical angle for light entering the core, thus providing for an increased acceptance angle 18. As such the optical fiber core diameter 22 can be suitably reduced, thereby providing for an increased optical fiber core numerical aperture.

The second cladding layer 26, possessing a second cladding layer refractive index 32, comprises un-doped silica.

The doping regime for the optical fiber according to a first aspect of the present invention provides for a reduced optical fiber core diameter 22 and thus an increased optical fiber core numerical aperture. This increases the optical power density of an optical transmission and has the effect of increasing Rayleigh backscatter coefficient of the fiber thus increasing the resultant Rayleigh backscatter. This backscatter increase enhances the sensitivity of the fiber in applications where the fiber is used as a sensing element.

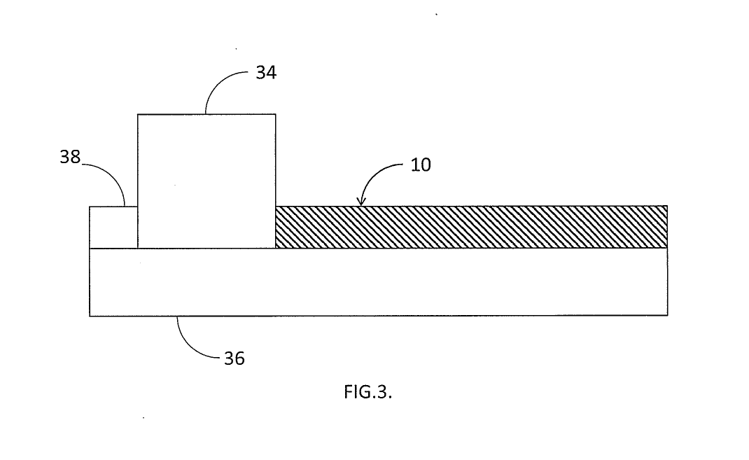

Referring to FIG. 3, a sectional diagram of a sensing system is shown, the sensing system incorporating an optical fiber 10 according to a first aspect of the present invention. Additional to the optical fiber 10, there is provided distributed acoustic sensor (DAS), used to interrogate the optical fiber 10 by providing an optical signal and detecting the level of backscatter provided. The use of an optical fiber 10 in the sensing system provides for increased sensitivity of the system, while maintain the range of the system due to signal losses remaining within a tolerable range. In the embodiment shown, the distributed acoustic sensor 34 is one of many deployed along a pipe-system 36 and is used for monitoring the properties of the pipe-system, such as fluid flow and temperature. The enhanced sensitivity of the system by virtue of the incorporation of optical fiber 10 allows the sensing system to detect smaller changes than were previously possible. The improved levels of signal attenuation allow for fewer interrogators 34 due to the ability to use optical fibers 10 that cover a much greater distance. As depth of oil wells continue to increase, together with more stringent global legislation on pipeline monitoring, the low-attenuation aspects of this invention are particularly relevant and important. In the embodiment shown, sensor 34 is further arranged to provide details from the interrogation of optical fiber 10 in order to inform a control system (not shown) of changes to the properties of pipe-system 36 by way of communication line 38. In this way, the sensing system can be used to inform a controller to enact changes to fluid provision to the pipe-system 36 as a result of real-time remote-monitoring of subtle changes within the pipe-system.

In the embodiments shown, germanium-comprising compounds were used to increase the optical fiber core refractive index, and fluorine-comprising compounds were used to reduce the first cladding layer refractive index. Alternative embodiments will be conceivable wherein other elements or compounds are used as doping agents to increase or decrease the refractive index in the present invention. In alternative embodiments, more than one doping agent may be used for each element, wherein the doping agents provide an increased or reduced refractive index in a cooperative manner, or wherein doping agents are used to counteract extreme refractive index changes caused by other doping agents.

Further alternative embodiment will be conceivable wherein the optical power within the core together with dopant-dependent backscatter sites are sufficient to cause backscatter without the use of optical gratings within the optical fiber core.

In the embodiments described, the second cladding layer 26 comprises no refractive index modifying doping agents. Additional embodiments will be envisioned wherein the second cladding layer comprises a second cladding layer dopant.

There are a number of applications envisaged for the sensing system according to the second aspect of the present invention. There are however, additional embodiments wherein these are not the only applications available for use of a sensing system according to this invention.

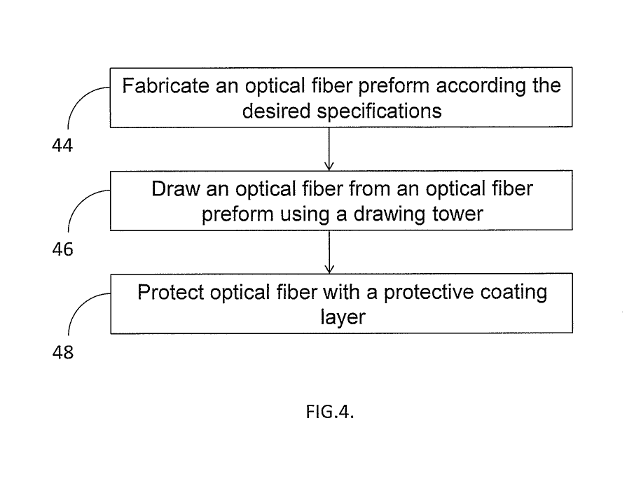

Referring to FIG. 4, a schematic of a method for manufacture of an optical fiber is shown. The method includes fabricating an optical fiber preform according to the desired specifications (44); drawing an optical fiber from the optical fiber preform using a drawing tower (46); and protecting the optical fiber with a protective coating layer (48).

It will be appreciated that the above described embodiments are given by way of example only and that various modifications thereto may be made without departing from the scope of the invention as defined in the appended claims.

1. An optical fiber for enhancing the sensitivity of a sensing system, the optical fiber comprising:
at least one core having a core diameter, a core numerical aperture, a core refractive index and a core Rayleigh backscatter coefficient;
a first cladding layer having a first cladding layer thickness, and a first cladding layer refractive index;
wherein the core comprises at least one core dopant selected from the range of: germanium, phosphorus, aluminium, boron, fluorine;
wherein at least one core dopant is used to increase the core refractive index and enhance the core Rayleigh backscatter coefficient;
the first cladding layer comprising at least one first cladding layer dopant selected from the range of: germanium, phosphorus, aluminium, boron, fluorine;
wherein at least one first cladding layer dopant is used to reduce the first cladding layer refractive index;
wherein the signal attenuation generated in the fiber is less than 20% over 1 km; and
wherein the core numerical aperture is greater than 0.13.

2. An optical fiber according to claim 1, wherein the core dopant used comprises one selected from the range: germanium at a concentration of up to 28 mol %; boron at a concentration of up to 24 mol %; fluorine at a concentration of up to 10 mol %.

3. An optical fiber according to claim 1, wherein the core numerical aperture is greater than 0.17.

4. An optical fiber according to claim 1, wherein the core numerical aperture is greater than 0.22.

5. An optical fiber according to claim 1, wherein the core numerical aperture is greater than 0.25.

6. An optical fiber according to claim 1, wherein the optical fiber diameter is in the range of 30 μm to 250 μm.

7. An optical fiber according to claim 1, wherein the optical fiber diameter is in the range of 50 μm to 125 μm.

8. An optical fiber according to claim 1, wherein the optical fiber diameter is in the range of 50 μm to 80 μm.

9. An optical fiber with enhanced Rayleigh backscatter sensitivity according to claim 1.

10. A sensing system comprising: at least one optical fiber according to claim 1 as a sensing element, the optical fiber being arranged to detect at least one predetermined parameter linked to a change in the back-scatter, the sensing system further comprising:
at least one input portion arranged to provide an optical signal and accept an optical signal;
and at least one detector portion arranged to accept an output optical signal.

11. A method of manufacture of an optical fiber according to claim 1, the method comprising:
a) fabricating an optical fiber preform according to the desired specifications according to claim 1;
b) drawing an optical fiber from a drawing tower; and further comprising
c) coating said glass fiber with a protective coating layer.

12. A method of manufacture of a sensing system as described in claim 10, the method comprising:
a) fabricating an optical fiber preform according to the desired specifications according to claim 1;
b) drawing an optical fiber from a drawing tower; and further comprising
c) coating said optical fiber with a protective coating layer.

13. An apparatus for the manufacture of an optical fiber as described in claim 1, the apparatus comprising: a fiber drawing tower, including tensioning apparatus and furnace apparatus; further comprising a coating station, a curing station and product spool storage.

14. An apparatus for the manufacture of a sensing system as described in claim 10, the apparatus comprising: a fiber drawing tower, including tensioning apparatus and furnace apparatus; further comprising a coating station, a curing station and product spool storage.
